(19) United States
(12) Patent Application Publication
(10) Pub. No.: US 2002/0005246 A1
(43) Pub. Date: Jan. 17, 2002

(54) GRID COMPRISING POLYMERIC, DRAWN STRIPS AND A PROCESS FOR MAKING SAME

(76) Inventors: ARIE HENDRIK FRANS VAN VLIET, ARNHEM (NL); SEBASTIAN MARTINUS PETERS, ZEVENAAR (NL)

Correspondence Address: OLIFF AND BERRIDGE PLC, P O BOX 19928, ALEXANDRIA, VA, 22320

(21) Appl. No.: 09/352,612

(22) Filed: Jul. 13, 1999

Related U.S. Application Data
(63) Continuation-in-part of application No. 09/202,069, filed on Jan. 4, 1999, now abandoned.
Application No. 09/202,069 is a 371 of international application No. PCT/EP97/03057, filed on Jun. 10, 1997.

(30) Foreign Application Priority Data
Jun. 11, 1996 (NL) 1003313

(51) Int. Cl. B32B 31/00

(52) U.S. Cl. 156/272.8

(57) ABSTRACT

A grid comprising drawn polymeric strips in at least two different directions, with the strips being bonded together in the zone or zones of overlap, may comprise at least one zone of overlap comprising at least two spatially separated bonding points or lines. These grids may exhibit improved strength and can be manufactured in a very efficient manner.

This is a Continuation-in-Part of application Ser. No. 09/202,069 filed Jan. 4, 1999, which in turn is a National Stage Application of International Application No. PCT/EP97/03057 filed Jun. 10, 1997. The entire disclosure of the prior applications is hereby incorporated by reference herein in its entirety.

### BACKGROUND OF THE INVENTION

1. Field of Invention

The invention pertains to a grid comprising drawn polymeric strips in at least two different directions, with the strips being bonded together in the zone or zones of overlap.

2. Description of Related Art

Such a grid is known from WO 94/26503, which discloses a process for bonding drawn polymeric strips to form, int. al., a grid. At and below the surface of at least one of the strips, particles are provided that heat up in an electromagnetic field having a frequency in the range of 10 to 50,000 MHz. Thus, the strips are bonded together in the zone or zones of overlap by being exposed to the field.

It was found, however, that when such a grid comprising drawn polymeric strips is subjected to heavy loads, for instance when it is used as a so-called “geogrid” (i.e., a geofabric composed of a grate or grid of longitudinal and transverse strips, which is used as soil consolidation in dike bodies, slopes, embankments, and the like), the loaded strips in the grid tend to break more quickly at the bonds than might expected on the basis of the strength of the strip itself and the bonding technique used.

### SUMMARY OF THE INVENTION

It is an object of the present invention to avoid this phenomenon of early rupture. This object may be achieved by the grid of the present invention.

The grid of the present invention comprises drawn polymeric strips in at least two different directions, with the strips being bonded together in the zone or zones of overlap. In the present invention, at least one zone of overlap comprises at least two spatially separated bonding points or lines, preferably such that the bonding points or lines are separated by an imaginary and straight line running in between and parallel to the sides of one of the strips.

### BRIEF DESCRIPTION OF THE DRAWINGS

FIG. 1 shows two strips joined by means of a weld in accordance with the present invention.

FIG. 2 shows, as a comparative example, two strips joined by a weld covering the entire zone of overlap.

### DETAILED DESCRIPTION OF EMBODIMENTS

It was found that a single weld or bond covering the entire zone of overlap or most of the zone of overlap results in an unfavorable interaction between the longitudinal and the transverse strips which, in turn, results in the aforementioned early rupture of strips that are heavily loaded. This will now be elucidated with reference to a geogrid.

Use is made of a geogrid in which drawn polymeric strips (12 mm in width, always spaced 30 mm apart) are welded together across their entire contact area at an angle of about 90 degrees. Because the strips are drawn, the molecular chains are predominantly oriented in the longitudinal direction of the strip. As a result of this orientation, the strips have a high tensile strength in the longitudinal direction and a low strain to failure in the transverse direction.

Forces exerted on the geogrid result in the strips being subjected to tensile load in both directions. On examination of one of the strips, the following was found: under the influence of the tensile force there is a certain elongation of the strip. At the point where this strip and another strip in the transverse direction of the geogrid (from now on “transverse strip”) are welded together across their entire contact area, this elongation generates a force transverse to the transverse strip. As was mentioned earlier, it is precisely in this direction that drawn strips have a lower strain to failure. Accordingly, heavier loads will cause the transverse strip to split.

In itself, such a split does not present a major problem to the geogrid. However, because the transverse strip and the loaded strip have been attached to each other across their entire contact surface, the split of the transverse strip will initiate a crack in the loaded strip. This crack in its turn gives rise to the early rupture of the loaded strip.

Separating the welds in the longitudinal direction of the loaded strip will mean, in the above-described situation, that the transverse strip will split between the welds. Once split, the transverse strip because of the separation of the welds is incapable of exerting any force on the loaded strip at the point of this split, and hence cannot cause early rupture of the loaded strip.

It is preferred that the zone of overlap comprises three or more spatially separated and parallel bonding lines. It has been found that, depending on the type of bonding used, the strength of grids that are loaded in a direction perpendicular to these lines can be virtually equal to the sum of the strips' strengths in that direction.

When the weld has separations in both directions of the geogrid, e.g., because there has only been spot welding near the angular points of the contact area, the above-described advantage applies in both directions of the geogrid. This can be of particular relevance in situations where the load to which the geogrid is subjected is likely to be about the same in both directions, or when it is not possible to accurately predict (the direction of) the load.

Preferably, the strips in the grid build an angle with each other ranging from 70 to 110 degrees, more preferably from 80 to 100 degrees, because such grids are comparatively strong and easy to manufacture.

Although the optimal width of the individual welds depends on the process conditions and the materials used and the person skilled in the art is capable of optimizing this width without undue experimentation, it is generally preferred that the width of the bonding lines and the width or diameter of the bonding spots or points is 5 mm or less, more preferably 3 nm or less. When the bonding lines or points are too wide, the phenomenon described above may occur within the bonding point or line.

As will be explained in more detail below, a grid in which the bonding points or lines are welded by means of a laser is preferred for a number of reasons.

The invention also pertains to a process for manufacturing the above-described grid in which at least two strips are successively placed one on top of the other, pressed together, and heated by means of a radiation source emitting electromagnetic radiation, wherein the strip that faces the radiation source is transparent to the radiation, while (at least) at the points where the strips are bonded together, the material absorbs the radiation.

It was found that by using this technique, a very strong weld can be produced quickly (within milliseconds) and economically, and allows great freedom in designing the configuration of the weld, all without influencing the oriented structure of the polymer of which the strips are made (due to very local heating).

The energy supplied to the surface to be bonded is preferably in the range of 20 to 150 kJ/m². Greater preference is given to quantities in the range of 40 to 110 kJ/m² or even 60 to 90 kJ/m². The surface to be bonded is preferably not exposed to the radiation for more than 75 milliseconds or less than 5 milliseconds. When these quantities of energy and the exposure times of the process according to the invention are used, the orientation of the molecular chains suffers minimal disturbance (and, hence, minimal loss of strength) and a bond having very good strength is achieved.

Suitable polymers include thermoplastic polymers such as polyesters, polyamides, and polyolefins. In addition, the radiation may be absorbed either by the polymer itself or by a pigment added to the polymer.

In a very simple embodiment, the strip facing the radiation source is made up wholly of transparent material. In that case, there are several options. For instance, the strip facing away from the radiation source may be made of an absorbent material. Alternatively, the strips to be bonded can both be transparent, with a (thin) layer, such as a film or foil, of an absorbent material sandwiched between the strips.

It will be evident that, in principle, any configuration can be used as long as there is a material that absorbs the radiation at the point where the bond is to be made and as long as the radiation can reach this material.

Another suitable embodiment is the one in which the strip facing the radiation source is composed of more than one component. For instance, use may be made of a bicomponent strip (width 12 mm; thickness 0.55 mm) of transparent polyester (0.50 mm thick) and polyester to which a pigment has been added (0.02 mm). This strip can be bonded to itself or to another strip in a number of ways, as long as the radiation is able to reach an absorbent section via a transparent section.

One advantage of the use of the multi-component strip is that it can serve both as an exposed and as an unexposed strip. Hence, there is no need during production to have two or more supply lines for two or more different materials.

Both the absorbing part of the strip comprising two or more components and the mentioned intermediate layer (foil or film) may have a very small thickness. Preferably, this thickness is in the range of 5 to 100 μm. However, in the selection of this thickness there will have to be taken into account, among others, the degree to which the material absorbs the radiation. In consequence, there is no absolute upper or lower limit.

Preferably, use is made of radiation with a wavelength in the range of 600 to 1600 nm. A large number of often inexpensive and reliable radiation sources is available for this range. Also, there are many pigments on the market that have high absorption in this range, e.g., carbon black.

Lasers are highly suitable for use in the process according to the invention. Unlike in the case of quartz lamps, the radiation emitted by lasers can be focused using comparatively simple means. Moreover, lasers have a narrow spectrum (“wavelength window”), which means that absorption by the transparent polymer can be avoided entirely or almost entirely. Lamps, on the other hand, have a comparatively wide spectrum, so that the emitted radiation will comprise wavelengths that are absorbed by the transparent polymer. In many cases, this not very desired absorption will be as much as about 35% of the total radiation energy. In the case of the invention, this absorption preferably does not exceed 15%.

When the power density can be varied, a lower strength can be selected for the part of the weld at the edge of the zone of overlap than for the part of the weld at and near the center of the zone of overlap. In this way, objectionable marginal phenomena, which are known to have a negative effect on the entire weld, can be suppressed or eliminated.

In a particularly preferred embodiment of the present invention, the zone or zones of overlap each comprise two polymeric strips, the upper and the lower strips, running in substantially the same direction as each other and a third polymeric strip sandwiched between the upper and lower polymeric strips and running in a different direction than the upper and lower strips and crossing the upper and lower strips at the zone of overlap. The third strip is bonded to both the upper and lower strips at the zone of overlap. At least one of and preferably both of the upper and lower strips are bonded to the third strip with at least two spatially separated bonding points or lines. In this embodiment, even if a force exerted on the grid leads to the tearing of one of the upper or lower strips from the zone of overlap, there is still one weld that holds the grid structure intact at the zone of overlap. In addition, a second weld at a zone of overlap may provide for an overall stronger connection between the strips, possibly rendering a stronger grid.

The structure of this embodiment can be easily prepared. For example, if the upper and lower strips are transparent to radiation, the radiation of a laser source positioned over the zone of overlap may be divided into two beams, one that penetrates the upper strip as described above, leading to a first weld. The other beam may be positioned so that it passes the zone of overlap and is sent into a prism positioned under the zone of overlap, which directs the beam such that it penetrates the lower strip, which results in a second weld to the third strip.

The invention will next be illustrated by way of an unlimitative example.

Welding is carried out with a solid state or diode laser (OPC-A020-MMM-CS) emitting light at a wavelength of 820 nm. The laser beam is transformed into a line shape having a width of 0.3 mm (Full Width Half Maximum of a Lorentzian intensity distribution) and a length of 6 mm (uniform “top hat” intensity distribution).

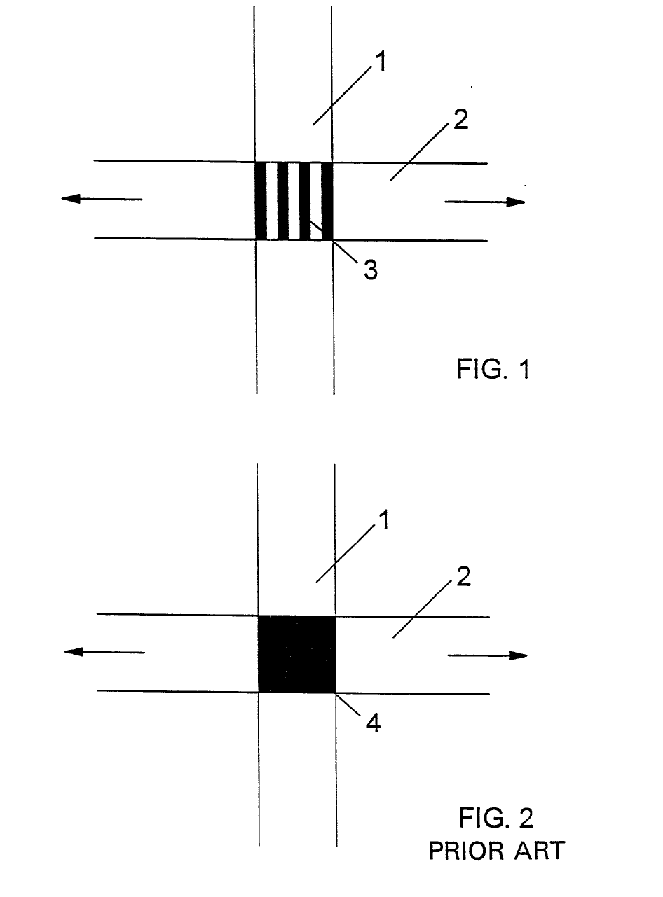

A transparent strip (numeral 1 in FIG. 1 and having a strength of 560 MPa and a cross-section of 12×0.55 mm²) of polyethylene terephthalate (PET) and a black strip (2) of the same type with carbon black added to the PET were placed one across the other at an angle of 90° and pressed together using a pressure of 1 megaPascal.

The line shaped beam is scanned across the zone of overlap of the strips at a speed of 2.25 centimeters per second. The laser beam was interrupted using 20 ms intervals, resulting in the bonding lines (3) being spaced 0.45 mm apart.

The procedure was repeated, but this time the weld (4), as demonstrated in FIG. 2, extended over the entire zone of overlap.

The welding experiments showed that, when cracks developed in the transparent transverse strip (1) during mechanical loading of the longitudinal black strip (numeral 2 in both Figures), the conventional weld (FIG. 2) suffered a large (˜15%) decrease in strength retention of the longitudinal black strip (2), whereas the weld according to the present invention (FIG. 1) suffered no such decrease in spite of the occurrence of cracks.

What is claimed is:

1. A grid comprising drawn polymeric strips in at least two different directions, with the strips being bonded together in at least one zone of overlap, wherein said at least one zone of overlap comprises at least two spatially separated bonding points or lines.

2. A grid according to claim 1, wherein said at least one zone comprises three or more spatially separated and parallel bonding lines.

3. A grid according to claim 1, wherein said at least one zone comprises at least one bonding point or line at or near each of the angular points of the at least one zone.

4. A grid according to claim 1, wherein the width of the points or lines is 5 mm or less.

5. A grid according to claim 4, wherein the width of the points or lines is 3 mm or less.

6. A grid according to claim 1, wherein the bonding points or lines are welded by means of a laser.

7. A grid according to claim 1, wherein the strength of a part of each bonding point or line at the edge of the at least one zone of overlap is lower than the strength of a part of each bonding point or line at and near the center of the at least one zone of overlap.

8. A grid according to claim 1, comprising, at the at least one zone of overlap, an upper strip, a lower strip, and a third strip sandwiched between and bonded to said upper and lower strips, said upper and lower strips running in substantially the same direction as each other and crossing said third strip.

9. A process for manufacturing the grid according to claim 1, comprising placing at least two strips one on top of the other, pressing the at least two strips together, and heating with a radiation source emitting electromagnetic radiation, wherein the strip that faces the radiation source is at least partially transparent to the radiation, while at the points where the strips are bonded together, the material absorbs said radiation.

10. A process according to claim 9, wherein the strip facing the radiation source is made entirely of transparent material.

11. A process according to claim 9, wherein the strip facing the radiation source comprises at least two different materials.

12. A process according to claim 9, wherein the radiation source used is a laser.
